(19) United States
(12) Patent Application Publication
(10) Pub. No.: US 2025/0044804 A1
(43) Pub. Date: Feb. 6, 2025

(54) AIR VEHICLE CONTROL SYSTEM, AIR VEHICLE CONTROL DEVICE, REMOTE CONTROL DEVICE, AIR VEHICLE, AIR VEHICLE CONTROL METHOD, AND AIR VEHICLE CONTROL PROGRAM

(71) Applicant: Nippon Telegraph and Telephone Corporation, Tokyo (JP)

(72) Inventors: Go Itami, Musashino-shi, Tokyo (JP); Tsuneko Kura, Musashino-shi, Tokyo (JP); Hiroshi MATSUBARA, Musashino-shi, Tokyo (JP); Jun KATO, Musashino-shi, Tokyo (JP)

(21) Appl. No.: 18/696,510

(22) PCT Filed: Oct. 18, 2021
(86) PCT No.: PCT/JP2021/038413

§ 371 Date: Mar. 28, 2024

(51) Int. Cl. G05D 1/247; G05D 1/617; G05D 1/654; G05D 109/20

(52) U.S. Cl. CPC G05D 1/247; G05D 1/617; G05D 1/6546; G05D 2109/20

(57) ABSTRACT

There are provided a distance acquisition unit (115) that detects a separation distance between a flight vehicle (V1) and a platform (51), a remaining amount acquisition unit (113) that acquires a remaining amount of a drive battery (16), a radio field intensity acquisition unit (114) that acquires a radio field intensity of a reception signal received by a communication unit (12), and a return control unit (112) that performs control to cause the flight vehicle (V1) to return to the platform (51) in at least one of a case where the remaining amount of the drive battery (16) falls below a lower limit remaining amount determined by the separation distance or a case where the radio field intensity falls below a lower limit intensity.

### TECHNICAL FIELD

The present invention relates to a flight vehicle control system, a flight vehicle control device, a remote control device, a flight vehicle, a flight vehicle control method, and a flight vehicle control program.

### BACKGROUND ART

Non Patent Literature 1 discloses observation of changes in scattering and reflection spectra of radio waves and light incident on the earth, and the like by a sensing method using a microwave band synthetic aperture radar or a sensing method using visible light and infrared rays. With the observation, it is possible to recognize a ground surface, a forest logging damage situation, an ozone hole, cloud, aerosol, spatial distribution and the temporal transition of harmful gas (NO2, SO2, or the like).

In Non Patent Literature 1, since statistical data is combined with captured image information, data reliability is insufficient.

To obtain actual observation data, various data such as weather information, environmental information, and disaster information are acquired by causing an unmanned flight vehicle such as a drone to fly in the sky.

### CITATION LIST

### Non Patent Literature

Non Patent Literature 1: The Ministry of Internal Affairs and Communications, “Yojigen cybercity no katsuyo ni muketa taskforce (dai ikkai) shiryo (in Japanese) (Taskforce (first round) materials for utilization of four-dimensional cyber city)”, 2018. Reference URL: https://www.soumu.go.jp/main_content/000534398.pdf

### SUMMARY OF INVENTION

### Technical Problem

However, in a case where the flight vehicle is caused to fly above a water surface of an ocean or a lake, the flight vehicle may not return to a platform that is a landing point due to a decrease in a remaining amount of a battery, a decrease in radio field intensity of a remote control signal, a contact with another flight vehicle, or the like. In such a case, the flight vehicle lands on the water surface of the ocean or the lake, and not only collected data cannot be acquired but also collection of the flight vehicle itself becomes difficult.

The present invention has been made in view of the above circumstances, and an object thereof is to provide a flight vehicle control system, a flight vehicle control device, a remote control device, a flight vehicle, a flight vehicle control method, and a flight vehicle control program capable of causing the flight vehicle flying above a water surface to reliably return to a platform.

### Solution to Problem

A flight vehicle control system according to one aspect of the present invention is a flight vehicle control system that controls a flight vehicle that flies above a water surface, the flight vehicle control system including: a flight vehicle control device provided in the flight vehicle; and a remote control device that transmits a remote control signal to the flight vehicle control device, in which either one of the flight vehicle control device or the remote control device includes a distance acquisition unit that acquires a separation distance between a return position where the flight vehicle returns and a current position of the flight vehicle, a remaining amount acquisition unit that acquires a remaining amount of a drive battery of the flight vehicle, a radio field intensity acquisition unit that acquires a radio field intensity of a reception signal received by the flight vehicle control device, and a return control unit that causes the flight vehicle to return to the return position in at least one of a case where the remaining amount of the drive battery falls below a lower limit remaining amount determined by the separation distance or a case where the radio field intensity falls below a lower limit intensity.

A flight vehicle control device according to one aspect of the present invention is a flight vehicle control device that controls a flight vehicle that flies above a water surface, the flight vehicle control device including: a distance acquisition unit that acquires a separation distance between a return position where the flight vehicle returns and a current position of the flight vehicle; a remaining amount acquisition unit that acquires a remaining amount of a drive battery of the flight vehicle; a radio field intensity acquisition unit that acquires a radio field intensity of a reception signal received by a communication unit; and a return control unit that causes the flight vehicle to return to the return position in at least one of a case where the remaining amount of the drive battery falls below a lower limit remaining amount determined by the separation distance or a case where the radio field intensity falls below a lower limit intensity.

A remote control device according to one aspect of the present invention is a remote control device that remotely controls a flight vehicle that flies above a water surface, the remote control device including: a distance acquisition unit that acquires a separation distance between a return position where the flight vehicle returns and a current position of the flight vehicle; a remaining amount acquisition unit that acquires a remaining amount of a drive battery of the flight vehicle; a radio field intensity acquisition unit that acquires a radio field intensity of a reception signal received by a communication unit of the flight vehicle; and a return control unit that causes the flight vehicle to return to the return position in at least one of a case where the remaining amount of the drive battery falls below a lower limit remaining amount determined by the separation distance or a case where the radio field intensity falls below a lower limit intensity.

A flight vehicle according to one aspect of the present invention is a flight vehicle having: a mirror surface member arranged on at least a part of a surface, the mirror surface member including a mirror surface, an optical filter that transmits a specific wavelength of light reflected by the mirror surface, and a polarizing plate that polarizes light transmitted through the optical filter.

A flight vehicle control method according to one aspect of the present invention is a flight vehicle control method for controlling a flight vehicle that flies above a water surface, the flight vehicle control method including: a step of acquiring a separation distance between a return position where the flight vehicle returns and a current position of the flight vehicle; a step of acquiring a remaining amount of a drive battery of the flight vehicle; a step of acquiring radio field intensity of a reception signal received by the flight vehicle; a step of detecting an approach or a collision between the flight vehicle and an obstacle; and a step of causing the flight vehicle to return to the return position in at least one of a case where the remaining amount of the drive battery falls below a lower limit remaining amount determined by the separation distance, a case where the radio field intensity falls below a lower limit intensity, or a case where the approach or the collision between the flight vehicle and an obstacle is detected.

One aspect of the present invention is a flight vehicle control program for causing a computer to function as the above-described flight vehicle control device.

### Advantageous Effects of Invention

According to the present invention, it is possible to cause the flight vehicle flying above the water surface to reliably return to the platform.

### BRIEF DESCRIPTION OF DRAWINGS

FIG. 1 is a block diagram illustrating a configuration of a flight vehicle control system according to a first embodiment.

FIG. 2 is an explanatory view illustrating a flight vehicle that has taken off from a platform and is flying.

FIG. 3 is an explanatory view illustrating a detailed configuration of a mirror surface member mounted on a surface of the flight vehicle.

FIG. 4 is a flowchart illustrating a processing procedure of the flight vehicle control system according to the first embodiment.

FIG. 5 is a flowchart illustrating a detailed processing procedure of self-propelling return processing.

FIG. 6 is an explanatory view illustrating a state in which the flight vehicle that has crashed to a sea surface is self-propelled and returns to the platform.

FIG. 7 is a block diagram illustrating a configuration of a flight vehicle control system according to a second embodiment.

FIG. 8 is a block diagram illustrating a hardware configuration according to the first and second embodiments.

### DESCRIPTION OF EMBODIMENTS

Hereinafter, embodiments of the present invention will be described with reference to the drawings.

### Configuration of First Embodiment

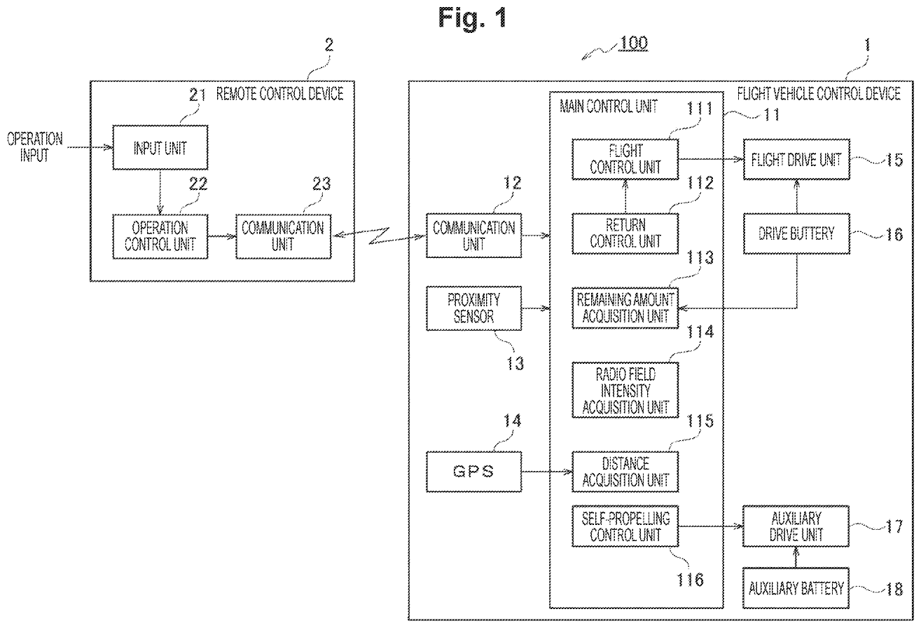

FIG. 1 is a block diagram illustrating a configuration of a flight vehicle control system 100 according to a first embodiment. As illustrated in FIG. 1, the flight vehicle control system 100 includes a flight vehicle control device 1 mounted on a flight vehicle and a remote control device 2 that remotely controls the flight vehicle.

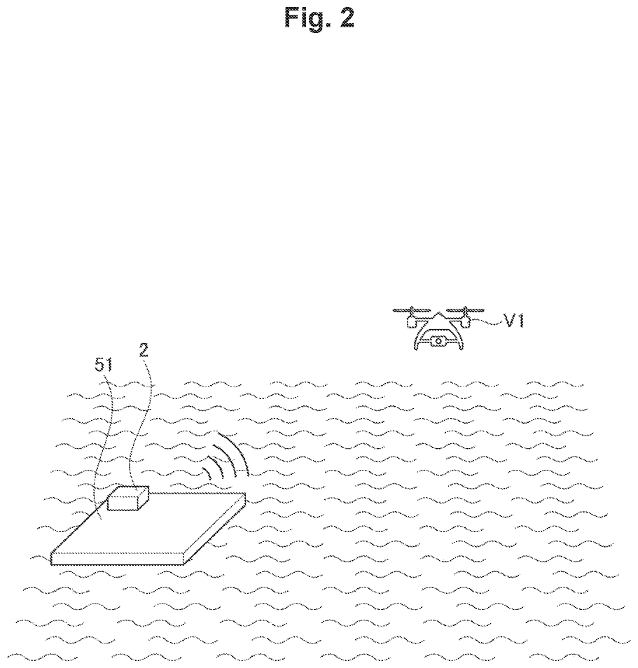

As illustrated in FIG. 2, the remote control device 2 is installed on or near a platform 51 installed on the sea, for example. The platform 51 is a return position where the flight vehicle V1 returns. Note that the remote control device 2 may not be installed near the platform 51 as long as wireless communication with the flight vehicle control device 1 is possible. In the present embodiment, an example in which the flight vehicle V1 flies above an ocean will be described, but the flight vehicle V1 may fly above a water surface of a lake.

The flight vehicle V1 takes off and lands on the platform 51. The flight vehicle V1 flies from the platform 51 as a starting point to a destination above the ocean, and returns to the platform 51 after work such as completion of data collection.

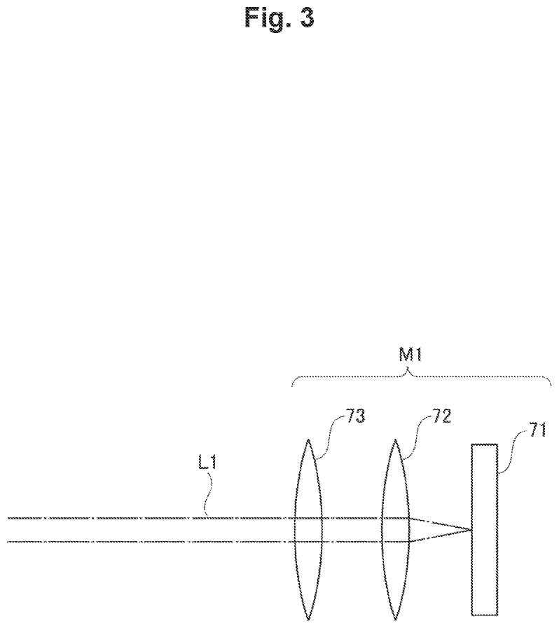

A mirror surface member is disposed on at least a part of a surface of the flight vehicle V1. FIG. 3 is an explanatory view schematically illustrating a configuration of a mirror surface member M1. As illustrated in FIG. 3, the mirror surface member M1 includes a mirror surface 71, an optical filter 72, and a polarizing plate 73.

As the light reflected by the mirror surface 71, a wavelength of light transmitted by the optical filter 72 is selected, and light having a unique wavelength is emitted. Light that has passed through the optical filter 72 is emitted as light L1 polarized by the polarizing plate 73. By attaching a similar polarizing plate to the platform 51 in advance, it is possible to distinguish the light L1 reflected by the mirror surface member M1 and normal light (white light).

That is, the platform 51 can specify and detect the light L1 reflected by the surface of the flight vehicle V1. Therefore, even in a case where the distance from the platform 51 to the flight vehicle V1 is long, the light L1 reflected by the flight vehicle V1 can be received. Therefore, even in a case where the flight vehicle V1 lands on the water surface and return is difficult, the position of the flight vehicle V1 can be easily recognized.

In addition, by combining a wavelength of the reflected light and polarized light, the degree of freedom in selecting individual identification is improved, and even in a case where a plurality of flight vehicles is caused to simultaneously fly, it is possible to easily identify each flight vehicle.

Returning to FIG. 1, the remote control device 2 includes an input unit 21, an operation control unit 22, and a communication unit 23.

The input unit 21 receives an input operation by an operator. By the input operation, for example, a flight path of the flight vehicle V1, information of collected data, and the like are input.

The operation control unit 22 generates a remote control signal for remotely controlling the flight vehicle V1 on the basis of an input command input by the input unit 21. The remote control signal includes a flight path, a destination, and information of collected data such as images, temperature, ultraviolet intensity, and carbon dioxide concentration, of the flight vehicle. The operation control unit 22 outputs the generated remote control signal to the communication unit 23.

The communication unit 23 wirelessly transmits the remote control signal generated by the operation control unit 22 to the flight vehicle V1.

The flight vehicle control device 1 includes a main control unit 11, a communication unit 12, a proximity sensor 13, a GPS 14, a flight drive unit 15, a drive battery 16, an auxiliary drive unit 17, and an auxiliary battery 18.

The communication unit 12 performs wireless communication with the communication unit 23 mounted on the remote control device 2.

The proximity sensor 13 detects that the flight vehicle V1 has approached (for example, 5 m or less) or has come into contact with an obstacle such as another flight vehicle while flying above the ocean. Note that, since a camera and a radar (FMCW radar and Doppler radar) are normally mounted on the flight vehicle V1 such as a drone, these camera and radar may also be used as the proximity sensor 13.

The GPS 14 receives a GPS signal transmitted from a GPS satellite and acquires position information of the flight vehicle V1. The position information is acquired as, for example, longitude and latitude information.

The flight drive unit 15 controls the flight of the flight vehicle V1. Specifically, the flight drive unit 15 controls the flight of the flight vehicle V1 so that a flight direction and a flight altitude become desired direction and altitude on the basis of a flight control signal output from a flight control unit 111 that will be described below.

The drive battery 16 supplies driving power to the flight drive unit 15.

The auxiliary drive unit 17 performs control to cause the flight vehicle V1 on the sea surface to be self-propelled and return to the platform 51 when the flight vehicle V1 lands on the sea surface due to a crash, forced landing, or the like. That is, the auxiliary drive unit 17 causes the flight vehicle V1 to be self-propelled above the water surface. The auxiliary drive unit 17 has a small structure that can be incorporated in the flight vehicle V1. The auxiliary drive unit 17 includes a screw (not illustrated) and a motor (not illustrated) that drives the screw. The auxiliary drive unit 17 can cause the flight vehicle V1 after landing on the water to be self-propelled and return to the platform 51 by driving the motor.

The auxiliary battery 18 is an emergency battery provided in a system different from the above-described drive battery 16. The auxiliary battery 18 supplies power to the auxiliary drive unit 17.

The main control unit 11 includes the flight control unit 111, a return control unit 112, a remaining amount acquisition unit 113, a radio field intensity acquisition unit 114, a distance acquisition unit 115, and a self-propelling control unit 116.

The flight control unit 111 outputs the flight control signal for driving the flight drive unit 15 on the basis of the remote control signal transmitted from the remote control device 2. When the flight control signal is input, the flight drive unit 15 controls the flight of the flight vehicle V1 so as to fly to a desired destination on the flight path input by the operator.

The remaining amount acquisition unit 113 acquires a remaining amount of the drive battery 16.

The radio field intensity acquisition unit 114 acquires a radio field intensity of a reception signal such as the remote control signal received by the communication unit 12. That is, the radio field intensity acquisition unit 114 acquires the radio field intensity of the reception signal received by the flight vehicle control device 1.

The distance acquisition unit 115 acquires a distance (hereinafter, referred to as a “separation distance”) from the platform 51 to a current position of the flight vehicle V1. Specifically, the distance acquisition unit 115 calculates the separation distance on the basis of the position information of the flight vehicle V1 acquired from the GPS 14 and the position information of the platform 51.

The return control unit 112 acquires the remaining amount of the drive battery 16 acquired by the remaining amount acquisition unit 113, the radio field intensity acquired by the radio field intensity acquisition unit 114, the separation distance between the flight vehicle V1 and the platform 51, and information of approach and contact with an obstacle by the proximity sensor 13. When it is predicted that the flight vehicle V1 cannot return to the platform 51 on the basis of each piece of the acquired information, the return control unit 112 outputs a return command of the flight vehicle V1 at a stage before the flight vehicle V1 cannot return.

Specifically, the return control unit 112 outputs the return command when the remaining amount of the drive battery 16 has reached the remaining amount (lower limit remaining amount) immediately before the remaining amount necessary for flying for the separation distance and returning to the platform 51. Further, in addition to the above-described separation distance, the lower limit remaining amount may be set in consideration of a surrounding flight environment such as wind and waves on the sea. Further, the return command may be output in a case where the remaining amount of the drive battery 16 becomes equal to or less than a certain lower limit remaining amount (for example, 10%).

The return control unit 112 outputs the return command when the above-described radio field intensity is lowered to an intensity (lower limit intensity, for example, −90 dB) or less immediately before outside a communication range. Further, the lower limit intensity may be set in consideration of propagation attenuation characteristics of the radio waves.

The return control unit 112 outputs the return command of the flight vehicle V1 in a case where it is detected that the flight vehicle V1 has approached an obstacle such as another flight vehicle or in a case where it is detected that the flight vehicle has come into contact with an obstacle by the proximity sensor 13.

That is, the return control unit 112 causes the flight vehicle V1 to return to the return position such as the platform 51 in at least one of a case where the remaining amount of the drive battery 16 falls below the lower limit remaining amount determined by the separation distance or a case where the radio field intensity falls below the lower limit intensity. Further, the return control unit 112 controls the flight vehicle V1 to return to the return position when the flight vehicle V1 has approached or has come into contact with an obstacle.

The self-propelling control unit 116 controls the auxiliary drive unit 17. The self-propelling control unit 116 outputs a drive command to the auxiliary drive unit 17 in a case where the flight vehicle V1 becomes difficult to fly and is forced to land or crashes on the sea surface and lands on the water. That is, when the flight vehicle V1 crashes on the sea surface, a strong impact is applied to the flight vehicle V1. When the impact at the time of landing on the water is detected, the self-propelling control unit 116 operates the auxiliary drive unit 17 and the auxiliary battery 18.

In a case where communication with the remote control device 2 is possible, the self-propelling control unit 116 drives the screw mounted on the auxiliary drive unit 17 to cause the flight vehicle V1 to be self-propelled and return to the platform 51. In a case where communication with the remote control device 2 is not possible and the self-propelled return is difficult, the self-propelling control unit 116 controls the flight vehicle V1 to stand by at the current position.

The self-propelling control unit 116 also calculates a direction of returning to the platform 51 from a relationship between the current position of the flight vehicle V1 acquired by the GPS 14 and the position of the platform 51, and controls the auxiliary drive unit 17 so that the landed flight vehicle V1 is directed to the platform 51. That is, when the flight vehicle V1 lands on the water surface, the self-propelling control unit 116 causes the flight vehicle V1 to return to the return position such as the platform 51.

### Operation of First Embodiment

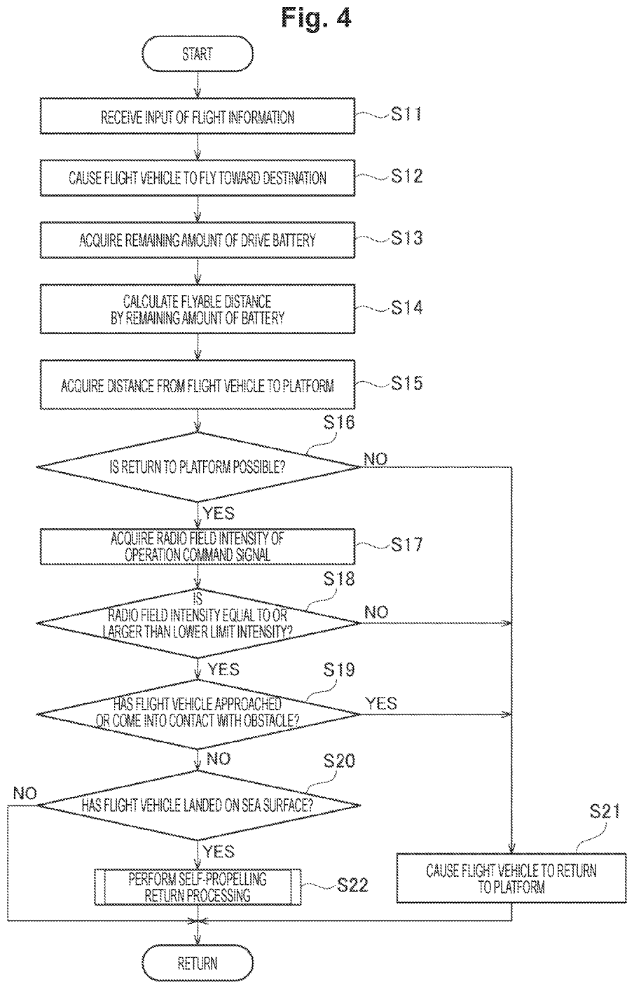

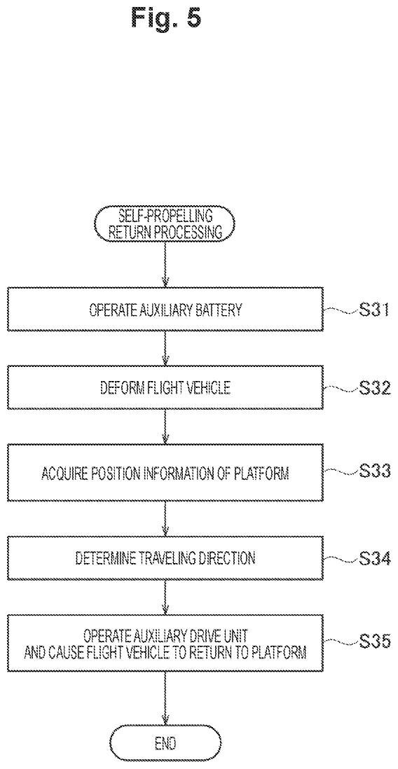

Next, an operation of the flight vehicle control system 100 according to the first embodiment configured as described above will be described. FIG. 4 is a flowchart illustrating a processing procedure of the flight vehicle control system 100 according to the first embodiment, and FIG. 5 is a flowchart illustrating a detailed processing procedure of “self-propelling return processing” illustrated in S22 of FIG. 4.

First, in step S11 in FIG. 4, the input unit 21 of the remote control device 2 receives inputs of various types of flight information by the operator. The operator inputs, for example, the destination above the ocean, the information of collected data, and the like. The operation control unit 22 generates the remote control signal on the basis of the input flight information. The generated remote control signal is transmitted from the communication unit 23 to the flight vehicle control device 1 and received by the communication unit 12 of the flight vehicle control device 1.

In step S12, the flight control unit 111 generates the flight control signal for causing the flight vehicle V1 to fly to the destination, and outputs the flight control signal to the flight drive unit 15. The flight vehicle V1 takes off from the platform 51 and starts flight toward the destination.

In step S13, the remaining amount acquisition unit 113 acquires the remaining amount of the drive battery 16.

In step S14, the remaining amount acquisition unit 113 calculates a flyable distance with the remaining amount of the drive battery 16. The relationship between the flight distance and the power consumed of the flight vehicle V1 is recognized in advance, and the flyable distance can be calculated on the basis of this relationship.

In step S15, the distance acquisition unit 115 acquires the current position information of the flight vehicle V1 from the GPS 14. The distance acquisition unit 115 calculates the distance (separation distance) from the platform 51 to the current position of the flight vehicle V1.

In step S16, the return control unit 112 determines whether the flight vehicle V1 can return to the platform 51 on the basis of the flyable distance calculated in the processing of step S14 and the separation distance calculated in the processing of step S15. In a case where the flyable distance is equal to or less than the separation distance, it is determined as NO since the return is not possible, and the processing proceeds to step S21. In a case where the flyable distance exceeds the separation distance, it is determined as YES since the return is possible, and the processing proceeds to step S17.

In step S21, the return control unit 112 outputs the return command of the flight vehicle V1 to the flight control unit 111. The flight control unit 111 controls the flight drive unit 15 to cause the flight vehicle V1 to return to the platform 51. Thereafter, the present processing is terminated.

In step S17, the radio field intensity acquisition unit 114 acquires the radio field intensity of the reception signal received by the communication unit 12.

In step S18, the return control unit 112 determines whether the radio field intensity acquired by the radio field intensity acquisition unit 114 is equal to or larger than the lower limit intensity. In a case where the intensity is equal to or larger than the lower limit intensity (S18; YES), the processing proceeds to step S19, and if not (S18; NO), the processing proceeds to step S21.

In step S19, the return control unit 112 determines whether the flight vehicle V1 has approached or has come into contact with an obstacle by the proximity sensor 13. In a case where the flight vehicle V1 has approached or has come into contact with the obstacle (S19; YES), the processing proceeds to step S21, and if not (S19; NO), the processing proceeds to step S20.

In step S20, the self-propelling control unit 116 determines whether the flight vehicle V1 has landed on the sea surface. In a case where the flight vehicle V1 has landed on the sea surface (S20; YES), the processing proceeds to step S22, and if not (S20; NO), the present processing is terminated.

In step S22, the self-propelling control unit 116 executes self-propelling return processing. FIG. 5 is a flowchart illustrating a processing procedure of the self-propelling return processing. Hereinafter, the processing procedure of the self-propelling return processing will be described with reference to FIG. 5.

First, in step S31, the self-propelling control unit 116 operates the auxiliary battery 18.

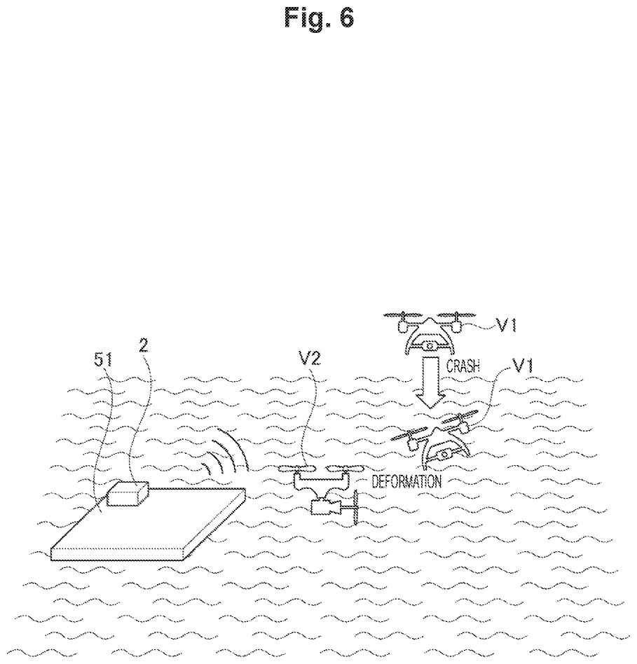

In step S32, the self-propelling control unit 116 transforms the flight vehicle V1 into a form of small ship so that the flight vehicle V1 can be self-propelled on the sea surface. Specifically, as indicated by reference numeral V2 in FIG. 6, the flight vehicle V1 is deformed so as to float on the sea surface.

In step S33, the self-propelling control unit 116 acquires the position information of the platform 51 on the basis of the reception signal received by the GPS 14.

In step S34, the self-propelling control unit 116 determines a traveling direction so that a deformed flight vehicle V2 is self-propelled toward the platform 51.

In step S35, the self-propelling control unit 116 drives the auxiliary drive unit 17 to cause the deformed flight vehicle V2 to return to the platform 51.

Thereafter, the present processing is terminated.

### Description of Second Embodiment

Next, a second embodiment will be described. In the above-described first embodiment, the example in which the distance acquisition unit 115, the remaining amount acquisition unit 113, the radio field intensity acquisition unit 114, and the return control unit 112 are mounted on the flight vehicle control device 1 has been described. However, the distance acquisition unit 115, the remaining amount acquisition unit 113, the radio field intensity acquisition unit 114, and the return control unit 112 may be mounted on either the flight vehicle control device 1 or the remote control device 2. In a second embodiment, an example in which each of the above components is mounted on a remote control device will be described.

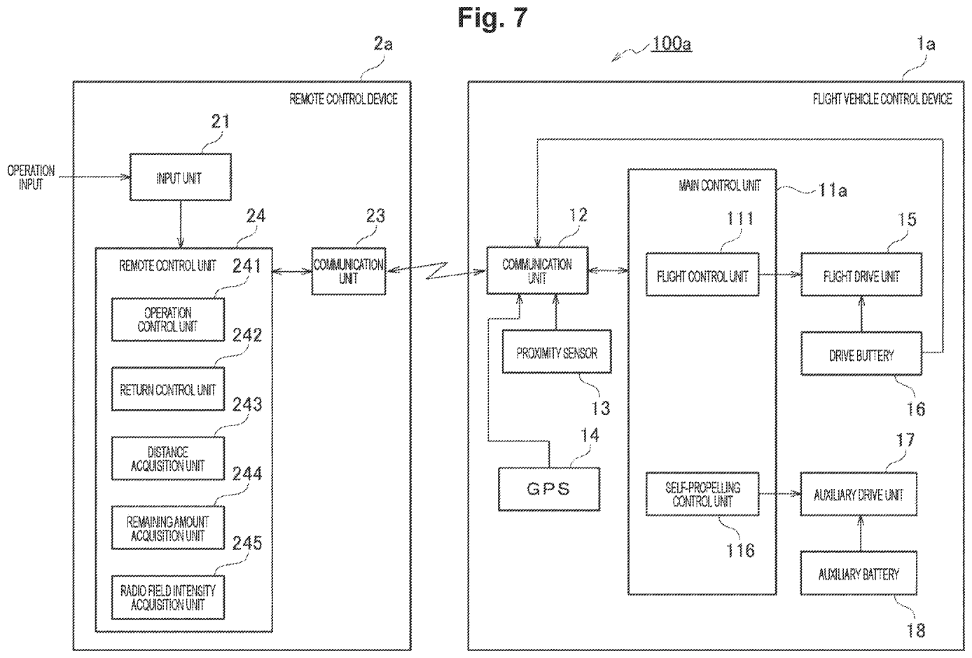

FIG. 7 is a block diagram illustrating a configuration of a flight vehicle control system 100a according to the second embodiment. As illustrated in FIG. 7, the flight vehicle control system 100a according to the second embodiment includes a flight vehicle control device 1a mounted on a flight vehicle and a remote control device 2a that remotely controls the flight vehicle.

The remote control device 2a includes an input unit 21, a communication unit 23, and a remote control unit 24.

Since the input unit 21 and the communication unit 23 are similar to those described in the first embodiment illustrated in FIG. 1, description thereof is omitted.

The remote control unit 24 includes an operation control unit 241, a return control unit 242, a distance acquisition unit 243, a remaining amount acquisition unit 244, and a radio field intensity acquisition unit 245.

The operation control unit 241 generates a remote control signal for remotely controlling a flight vehicle V1 on the basis of an input command input by the input unit 21. The remote control signal includes a flight path, a destination, and information of collected data such as images, temperature, ultraviolet intensity, and carbon dioxide concentration, of the flight vehicle V1.

The remaining amount acquisition unit 244 acquires a remaining amount of a drive battery 16 mounted on the flight vehicle control device 1a via the communication unit 12 and the communication unit 23.

The radio field intensity acquisition unit 245 acquires a radio field intensity of a reception signal such as a flight vehicle control signal received by the communication unit 12 of the flight vehicle control device 1a.

The distance acquisition unit 243 acquires a separation distance from a platform 51 to a current position of the flight vehicle V1. Specifically, the distance acquisition unit 243 acquires the position information of the flight vehicle V1 acquired by a GPS 14 mounted on the flight vehicle control device 1a via the communication unit 12 and the communication unit 23. The distance acquisition unit 243 calculates the separation distance from the platform 51 to the flight vehicle V1 on the basis of the position information of the flight vehicle V1 and position information of the platform 51.

The return control unit 242 acquires the remaining amount of the drive battery 16 acquired by the remaining amount acquisition unit 244, the radio field intensity acquired by the radio field intensity acquisition unit 245, the separation distance between the flight vehicle V1 and the platform 51, and information of approach and contact with an obstacle by a proximity sensor 13 mounted on the flight vehicle control device 1a. When it is predicted that the flight vehicle V1 cannot return to the platform 51 on the basis of each piece of the acquired information, the return control unit 242 outputs a return command of the flight vehicle V1 at a stage before the flight vehicle V1 cannot return.

The flight vehicle control device 1a includes a main control unit 11a, the communication unit 12, the proximity sensor 13, a GPS 14, a flight drive unit 15, the drive battery 16, an auxiliary drive unit 17, and an auxiliary battery 18.

Since the communication unit 12, the proximity sensor 13, the GPS 14, the flight drive unit 15, the drive battery 16, the auxiliary drive unit 17, and the auxiliary battery 18 have the same configurations as those illustrated in FIG. 1, the same reference numerals are given to them and description thereof is omitted.

The main control unit 11a includes a flight control unit 111 and a self-propelling control unit 116.

The flight control unit 111 outputs a flight control signal for driving the flight drive unit 15 on the basis of the remote control signal transmitted from the remote control device 2. When the flight control signal is input, the flight drive unit 15 controls the flight of the flight vehicle V1 so as to fly to a desired destination on the flight path input by an operator. When a return command is output from the return control unit 242 of the remote control device 2a, the flight control unit 111 controls the flight drive unit 15 to cause the flight vehicle V1 to return to the platform 51.

The self-propelling control unit 116 outputs a drive command to the auxiliary drive unit 17 in a case where the flight vehicle V1 becomes difficult to fly and is forced to land or crashes on the sea surface and lands on the water. The self-propelling control unit 116 detects that the flight vehicle V1 has landed on the sea surface on the basis of the current position of the flight vehicle V1 acquired by the GPS 14. Note that it may be configured to detect that the flight vehicle V1 has landed on the sea surface using an acceleration sensor or the like.

The self-propelling control unit 116 calculates a direction of returning to the platform 51 from a relationship between the current position of the flight vehicle V1 acquired by the GPS 14 and the position of the platform 51, and controls the auxiliary drive unit 17 so that the landed flight vehicle V1 is directed to the platform 51.

An operation of the flight vehicle control system 100a according to the above-described second embodiment is different from that of the above-described first embodiment only in that the processing of the distance acquisition unit 243, the processing of the remaining amount acquisition unit 244, the processing of the radio field intensity acquisition unit 245, and the processing of the return control unit 242 are executed by the remote control device 2a, and other processing is similar to the processing of the flowcharts illustrated in FIGS. 4 and 5. Therefore, description of a processing procedure of the flight vehicle control system 100a according to the second embodiment is omitted.

### Effects of the Embodiment

As described above, the first and second embodiments relate to a flight vehicle control system that controls a flight vehicle V1 that flies above a water surface, the flight vehicle control system including a flight vehicle control device provided in the flight vehicle V1; and a remote control device that transmits a remote control signal to the flight vehicle control device, in which either one of the flight vehicle control device or the remote control device includes a distance acquisition unit that acquires a separation distance between a platform 51 (return position) where the flight vehicle V1 returns and a current position of the flight vehicle V1, a remaining amount acquisition unit that acquires a remaining amount of a drive battery of the flight vehicle V1, a radio field intensity acquisition unit that acquires a radio field intensity of a reception signal received by the flight vehicle control device, and a return control unit that causes the flight vehicle V1 to return to the return position in at least one of a case where the remaining amount of the drive battery falls below a lower limit remaining amount determined by the separation distance or a case where the radio field intensity falls below a lower limit intensity.

According to the first and second embodiments, the flight vehicle V1 flying above the sea surface can reliably return to the platform 51. Therefore, it is possible to reliably collect various data collected by the flight vehicle V1. In addition, it is possible to prevent the flight vehicle V1 from sinking in the water and becoming unrecoverable.

Furthermore, in the case where the flight vehicle V1 lands on the sea surface, the flight vehicle V1 can be self-propelled and return to the platform 51. Therefore, even in the case where the return by flight is not possible, the flight vehicle V1 can reliably return to the platform 51.

In the first and second embodiments, the mirror surface member M1 is provided on at least a part of the surface of the flight vehicle V1. Therefore, when the mirror surface member M1 is irradiated with light, the light is reflected and polarized in a predetermined direction. In the case where the flight vehicle V1 lands on the sea surface and cannot return, it is possible to easily search for the flight vehicle V1 even in the case where the current position of the flight vehicle V1 is lost by detecting the light reflected by the mirror surface member M1.

In addition, in the flight vehicle control system 100a according to the second embodiment, since the distance acquisition unit 243, the remaining amount acquisition unit, the radio field intensity acquisition unit 245, and the return control unit 242 are mounted on the remote control device 2a, functions mounted on the flight vehicle V1 can be simplified, and the size and weight of the flight vehicle V1 can be reduced.

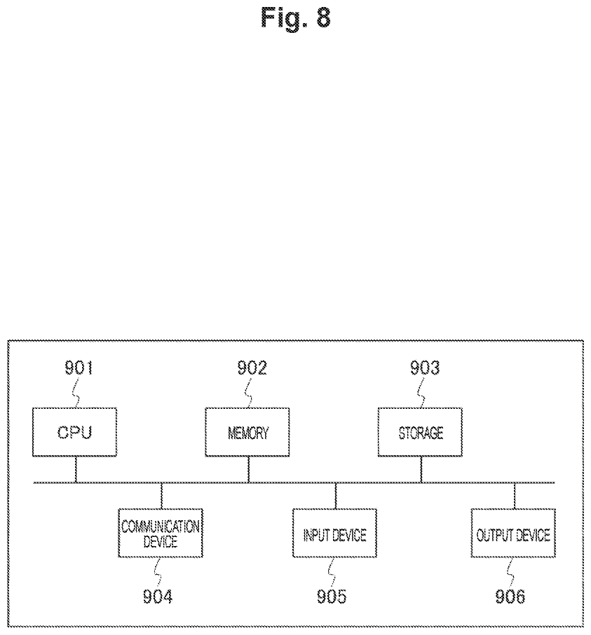

As illustrated in FIG. 8, for example, a general-purpose computer system including a central processing unit (CPU, processor) 901, a memory 902, a storage 903 (a hard disk drive (HDD) or a solid state drive (SSD)), a communication device 904, an input device 905, and an output device 906 can be used as the flight vehicle control device 1 or 1a and the remote control device 2 or 2a of the above-described first or second embodiment. The memory 902 and the storage 903 are storage devices. In the computer system, the CPU 901 executes a predetermined program loaded on the memory 902, whereby each of the functions of the flight vehicle control device 1 or 1a and the remote control device 2 or 2a is implemented.

Note that the flight vehicle control device 1 or 1a and the remote control device 2 or 2a may be implemented by one computer or may be implemented by a plurality of computers. Further, the flight vehicle control device 1 or 1a and the remote control device 2 or 2a may be virtual machines mounted on a computer.

Note that a program for the flight vehicle control device 1 or 1a and the remote control device 2 or 2a can be stored in a computer-readable recording medium such as an HDD, an SSD, a universal serial bus (USB) memory, a compact disc (CD), or a digital versatile disc (DVD), or can be distributed via a network.

The present invention is not limited to the above embodiment, and various modifications can be made within the scope of the spirit of the present invention.

### REFERENCE SIGNS LIST

1, 1a Flight vehicle control device
2, 2a Remote control device
11, 11a Main control unit
12 Communication unit
13 Proximity sensor
15 Flight drive unit
16 Drive battery
17 Auxiliary drive unit
18 Auxiliary battery
21 Input unit
22 Operation control unit
23 Communication unit
24 Remote control unit
51 Platform
71 Mirror surface
70 Optical filter
73 Polarizing plate
100, 100a Flight vehicle control system
111 Flight control unit
110, 242 Return control unit
113, 244 Remaining amount acquisition unit
114, 245 Radio field intensity acquisition unit
115, 243 Distance acquisition unit
116 Self-propelling control unit
241 Operation control unit
M1 Mirror surface member
V1 Flight vehicle

1. (canceled)

2. A flight vehicle control device for controlling a flight vehicle that flies above a water surface, the flight vehicle control device comprising:
a distance acquisition unit, including one or more processors, configured to acquire a separation distance between a return position where the flight vehicle returns and a current position of the flight vehicle,
a remaining amount acquisition unit, including one or more processors, configured to acquire a remaining amount of a drive battery of the flight vehicle,
a radio field intensity acquisition unit, including one or more processors, configured to acquire a radio field intensity of a reception signal received by the flight vehicle control device, and
a return control unit, including one or more processors, configured to cause the flight vehicle to return to the return position in at least one of a case where the remaining amount of the drive battery falls below a lower limit remaining amount determined by the separation distance or a case where the radio field intensity falls below a lower limit intensity.

3. The flight vehicle control device according to claim 2, further comprising:
a proximity sensor configured to detect that the flight vehicle approaches or comes into contact with an obstacle, wherein
the return control unit is configured to cause the flight vehicle to return to the return position when the flight vehicle approaches or comes into contact with the obstacle.

4. The flight vehicle control device according to claim 2, further comprising;
an auxiliary drive unit, including one or more processors, configured to cause the flight vehicle to be self-propelled above the water surface;
an auxiliary battery configured to supply power to the auxiliary drive unit; and
a self-propelling control unit, including one or more processors, configured to control the auxiliary drive unit, wherein
the self-propelling control unit is configured to cause the flight vehicle to return to the return position when the flight vehicle lands on the water surface.

5. A remote control device for remotely controlling a flight vehicle that flies above a water surface, the remote control device comprising:
a distance acquisition unit, including one or more processors, configured to acquire a separation distance between a return position where the flight vehicle returns and a current position of the flight vehicle,
a remaining amount acquisition unit, including one or more processors, configured to acquire a remaining amount of a drive battery of the flight vehicle,
a radio field intensity acquisition unit, including one or more processors, configured to acquire a radio field intensity of a reception signal received by the flight vehicle control device, and
a return control unit, including one or more processors, configured to cause the flight vehicle to return to the return position in at least one of a case where the remaining amount of the drive battery falls below a lower limit remaining amount determined by the separation distance or a case where the radio field intensity falls below a lower limit intensity.

6. A flight vehicle having:
a mirror surface member arranged on at least a part of a surface, the mirror surface member including
a mirror surface,
an optical filter that transmits a specific wavelength of light reflected by the mirror surface, and
a polarizing plate that polarizes light transmitted through the optical filter.

7. (canceled)

8. A non-transitory computer-readable storage medium storing a flight vehicle control program causing a computer to function as the flight vehicle control device according to claim 2.
